(19) United States
(12) Patent Application Publication
(10) Pub. No.: US 2008/0043317 A1
(43) Pub. Date: Feb. 21, 2008

(54) E-ink display panel

(75) Inventors: Yu-Chen Hsu, Hsinchu (TW); Chi-Ming Wu, Hsinchu (TW)

Correspondence Address: SHEEHAN PHINNEY BASS & GREEN, PA;c/o PETER NIEVES, 1000 ELM STREET, MANCHESTER, NH, 03105-3701, US

(73) Assignee: Prime View International Co., Ltd., Hsinchu (TW)

(21) Appl. No.: 11/709,988

(22) Filed: Feb. 23, 2007

(30) Foreign Application Priority Data
Aug. 21, 2006 (TW) 95130727

(51) Int. Cl. G02B 26/00

(52) U.S. Cl. 359/296

(57) ABSTRACT

An E-ink display panel is provided. In the E-ink display panel, a dielectric layer having a thickness of 1˜4 μm is disposed on bottom-gate thin film transistors to prevent the pixel electrodes from being interfered by noise generated by the bottom-gate thin film transistors, the scan lines and the data lines. Therefore, the display quality of the E-ink display panel is improved.

### RELATED APPLICATIONS

The present application is based on, and claims priority from, Taiwan Application Serial Number 95130727, filed Aug. 21, 2006, the disclosure of which is hereby incorporated by reference herein in its entirety.

### BACKGROUND

1. Field of Invention

The present invention relates to a display panel. More particularly, the present invention relates to an E-ink display panel.

2. Description of Related Art

The E-ink display device of the first generation was developed in 1970. The first generation E-ink display device comprises many charged little balls. One side of the balls is white, and the other side thereof is black. When the applied electric field is changed, the balls will rotate to show white or black color. The E-ink display device of the second generation was developed in 1990. The second generation E-ink display device uses microcapsules to replace the charged balls stated above. The capsules filled with colored oil and white-colored particles inside. An external electrical field is applied to the white-colored particles to control their motions. When the white-colored particles move upward (in the direction toward the reader), the E-ink display device will show white color. When the white-colored particles move downward (in the direction away from the reader), the E-ink display device will show the color of the oil.

E-ink paper has as high contrast as regular paper and is easy to read. Moreover, E-ink paper has low power consumption, flexible, lightweight and portable. Because of these advantages, E-ink like a PDA, a mobile phone and an electronic reader has become a solution to be a highly readable and information intensive portable means in any dynamic light environment.

### SUMMARY

An E-ink display panel is thus provided. In the E-ink display panel, the thickness of the dielectric layer which is disposed between the bottom-gate thin film transistors (TFTs) and the pixel electrodes prevents the pixel electrodes from being interfered by noise generated by the bottom-gate TFTs, the scan lines and the data lines. Therefore, the display quality of the E-ink display panel can be improved.

In accordance with the foregoing and other objectives of the present invention, an E-ink display panel is provided. The E-ink display panel comprises an active array substrate, an opposite substrate and an E-ink display medium. The active array substrate comprises a substrate, scan lines, data lines and pixel structures. The pixel structures are separately electrically connected with and driven by the scan lines and the data lines on the substrate. Each pixel structure comprises a bottom-gate TFT, a dielectric layer and a pixel electrode. The bottom-gate TFT comprises a gate electrode, a source electrode and a drain electrode. The gate electrode is electrically connected with one of the scan lines, and the source electrode is electrically connected with one of the data lines. The dielectric layer is disposed on the bottom-gate TFT. The dielectric layer has a contact window to expose a portion of the drain electrode of the bottom-gate TFT, and the thickness of the dielectric layer is about 1˜4 μm. The pixel electrode on the dielectric layer is electrically connected with the drain electrode through the contact window. The opposite substrate is disposed corresponding to the active array substrate. The E-ink display medium is disposed between the active array substrate and the opposite substrate.

In an embodiment, the pixel electrode covers the corresponding bottom-gate TFT and the data line that is electrically connected with the pixel electrode. In another embodiment, the pixel electrode further covers the scan line that is electrically connected with the pixel electrode. In still another embodiment, the pixel electrode covers the adjacent scan lines and/or date lines that are not electrically connected with the pixel electrode.

In conclusion, the dielectric layer with a thickness of about 1˜4 μm is disposed between the bottom-gate TFTs of the active array substrate and the pixel electrodes in the invention. The thickness of the dielectric layer can prevent the pixel electrodes from being interfered by noise generated by the bottom-gate TFTs, the scan lines and the data lines. Therefore, the display quality of the E-ink display panel can be improved. Moreover, the thickness of the dielectric layer can make the surface of the active array substrate even flatter.

These and other features, aspects, and advantages of the present invention will become better understood with reference to the following description and appended figures.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1A is a top view of an active array substrate of an E-ink display panel according to an embodiment of the invention;

FIG. 1B is a cross-section view of an active array substrate of an E-ink display panel of FIG. 1A along line A-A′; and

FIG. 1C is a structural diagram of an E-ink display panel according to another embodiment of the invention.

### DETAILED DESCRIPTION

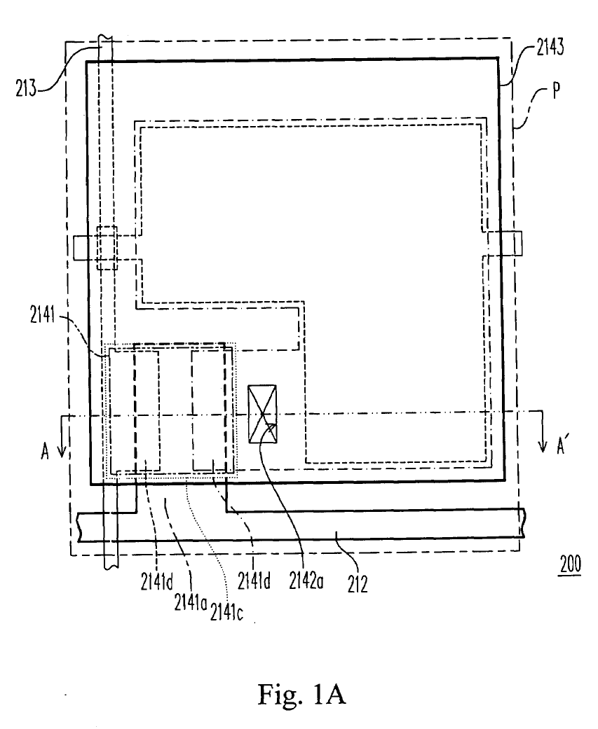

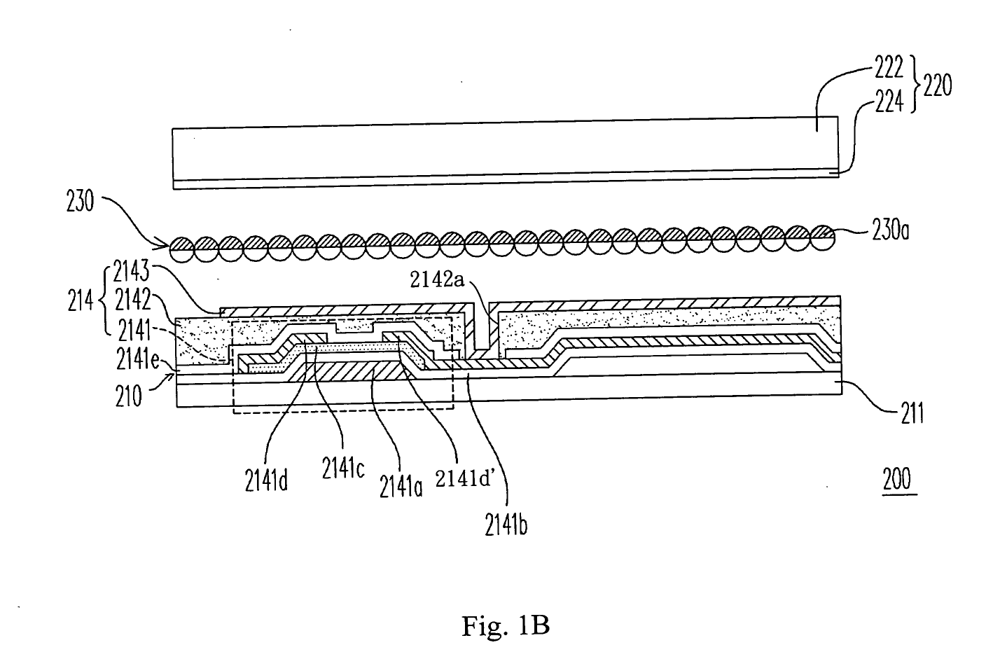

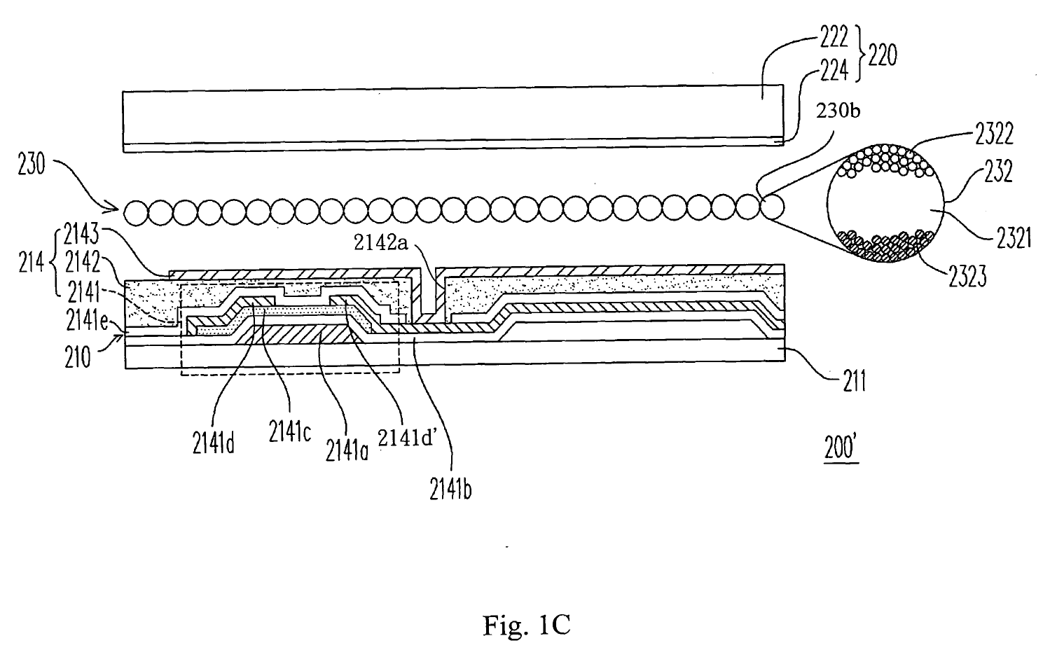

FIG. 1A is a top view of an active array substrate of an E-ink display panel according to an embodiment of the invention. FIG. 1B is a cross-section view of an active array substrate of an E-ink display panel of FIG. 1A along line A-A′. FIG. 1A and FIG. 1B show only one pixel of the E-ink display panel. Please refer to FIG. 1B, the E-ink display panel 200 comprises mainly an active array substrate 210, an opposite substrate 220 and a display medium 230. Structure of elements and correlation thereof will be illustrated below with figures.

Please refer to FIG. 1A and FIG. 1B. The active array substrate 210 comprises a substrate 211, scan lines 212, data lines 213 and pixel structures 214. The substrate 211 can be a glass substrate, a plastic substrate or other types of substrates. The scan lines 212 and the data lines 213 are perpendicular to each other on the substrate 2111. The pixel structures 214 are arranged in a matrix to define pixel regions P. Moreover, the pixel structures 214 are electrically connected with and driven by the scan lines 212 and the data lines 213. Each pixel structure 214 comprises a bottom-gate thin film transistor (TFT) 2141, a dielectric layer 2142 and a pixel electrode 2143.

A bottom-gate TFT 2141 comprises a gate electrode 2141a, a gate isolation layer 2141b, a channel layer 2141c, a source electrode 2141d and a drain electrode 2141d′. The gate electrode 2141a is disposed on the substrate 211 and is electrically connected with the scan line 212. The gate isolation layer 2141b is disposed on the substrate 211 and covers the gate electrode 2141a. The channel layer 2141c is disposed on the gate isolation layer 2141b above the gate electrode 2141a. The source electrode 2141d and the drain electrode 2141d′ are at two sides of the channel layer 2141c. The drain electrode 2141d is electrically connected with the data line 214. A protection layer 2141e can be selectively formed on the gate-bottom TFT 2141, the scan line 212 and the data line 231 to protect underlying elements from damage and moisture. The material of the protection layer 2141e is usually silicon nitride (SiₓN_{y}) or silicon oxide. The thickness of the protection layer 2141e is a few thousand angstroms.

The dielectric layer 2142 with a thickness of about 1˜4 μm is disposed on the gate-bottom TFT 2141. The dielectric layer 2142 covers the whole substrate 211 including the data lines 212 and the scan lines 213. The thickness of the dielectric layer 2142 is capable to shield the noise interference from bottom-gate TFTs 2141 underlying the pixel electrodes 2143, the scan lines 212 and the data lines 213. Therefore, noise influence on the pixel electrode 2143 can be ignored. The dielectric layer 2142 is made from a photo resist material or a resin material. When the dielectric layer 2142 is made from a photo resist material, the dielectric layer 2142 can be defined to form contact windows 2142a by photolithography.

The contact window 2142a in the dielectric layer 2142 exposes a portion of the drain electrode 2142d′ of the bottom-gate TFT 2141. The pixel electrode 2143 on the dielectric layer 2142 is electrically connected with the drain electrode 2141d′ of the bottom-gate TFT 2141 through the contact window is 2142a in the dielectric layer 2142. The material of the pixel electrode 2143 is indium tin oxide (ITO) or indium zinc oxide (IZO). In the embodiment, the pixel electrode 2143 completely covers the corresponding bottom-gate TFT 2141 and the data line 213 that is electrically connected with the pixel electrode 2143. In another embodiment, the pixel electrode 2143 can cover the scan line 212 that is electrically connected with the pixel electrode 2143. In still another embodiment, the pixel electrode 2143 can further covers the scan lines and/or the data lines that are not electrically connected with the pixel electrode 2143.

In FIG. 1B, the opposite substrate 220 is disposed correspondingly to the active array substrate 210. The opposite substrate 220 comprises a substrate 222 and a common electrode 224. The common electrode 224 can be a transparent conductive layer. The display medium 230 is disposed between the active array substrate 210 and the opposite substrate 220.

The display medium 230 is at least bi-stable. The display medium 230 can keep display images even the applied signal is removed. In the embodiment, the display medium comprises many E-ink particles 230a. One side of each E-ink particle 230a is light-colored, and the other side thereof is dark-colored. The two separate sides of the E-ink particles 230a have different electric characteristics. When the electric field between the pixel electrode 2143 and the common electrode 224 is changed, the E-ink particles 230a will be driven to display images on the E-ink display panel 200.

The display medium 230 is not limited to the type stated above. FIG. 1C is a structural diagram of an E-ink display panel according to another embodiment of the invention. In the E-ink display panel 200′ of FIG. 1C, display medium 230 comprises dark-colored particles 2323, light-colored particles 2322 and a transparent fluid 2321. The dark-colored particles 2323 and the light-colored particles 2322 are distributed in the transparent fluid 2321 and have different electrical characteristics. When the electrical filed between the pixel electrode 2143 and the common electrode 224 is changed, the dark-colored particles 2323 and the light-colored particles 2322 will move upward and downward according to the direction of the electrical field and thus to enable each pixel to show the colors of different particles. In still another embodiment, the display medium 230 comprises single charge colored particles suspended in a colored liquid. The single charge colored particles will move upward or downward according to the direction of the electric field and thus to enable each pixel to show the colors of the colored particles and the colored liquid.

In a further embodiment, the display medium 230 is wrapped inside microcapsules. In another embodiment, the display medium 230 is contained in microcups. In an embodiment, the display medium 230 can move in the active regions freely and is not limited to a side structural body. In other embodiments, the display medium 230 can be arranged according to different structures. The type and arrangement of the display medium 230 is not limited by the above embodiments.

In conclusion, the dielectric layer 2142 with a thickness of about 1˜4 μm is disposed between the bottom-gate TFTs of the active array substrate and the pixel electrodes in the E-ink display panel according to the embodiments of the invention. The dielectric layer can shield the noise interference from the bottom-gate TFTs, the scan lines and the data lines. Therefore, the noise interference on the pixel electrodes is greatly reduced, and the display quality of the E-ink display panel can be improved. Moreover, the thickness of the dielectric layer can make the surface of the active array substrate even flatter.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An E-ink display panel, comprising:
an active array substrate, comprising:
a substrate;
a plurality of scan lines and a plurality of data lines disposed on the substrate;
a plurality of pixel structures electrically connected with and driven by the scan lines and the data lines respectively, wherein each of the pixel structures, comprising:
a bottom-gate thin film transistor (TFT), which comprises a gate electrode, a source electrode and a drain electrode, wherein the gate electrode is electrically connected with one of the scan lines, and the source electrode is electrically connected with one of the data lines;
a dielectric layer disposed on the bottom-gate TFT, wherein the dielectric layer has a contact window to expose a portion of the drain electrode, and the thickness of the dielectric layer is about 1˜4 μm; and
a pixel electrode disposed on the dielectric layer and electrically connected with the drain electrode through the contact window;
an opposite substrate disposed corresponding to the active array substrate; and
an E-ink display medium disposed between the active array substrate and the opposite substrate.

2. The E-ink display panel of claim 1, wherein the active array substrate further comprises a protection layer to cover the bottom-gate TFTs, the scan lines and the data lines.

3. The E-ink display panel of claim 2, wherein the material of the protection layer is silicon nitride or silicon oxide.

4. The E-ink display panel of claim 1, wherein the dielectric layer is made from a photo resist material or a resin material.

5. The E-ink display panel of claim 1, wherein the dielectric layer covers the scan lines and the data lines.

6. The E-ink display panel of claim 5, wherein the pixel electrode covers the data line that is electrically connected with the pixel electrode.

7. The E-ink display panel of claim 5, wherein the pixel electrode covers the scan line that is electrically connected with the pixel electrode.

8. The E-ink display panel of claim 5, wherein the pixel electrode covers the adjacent data lines that are not electrically connected with the pixel electrode.

9. The E-ink display panel of claim 5, wherein the pixel electrode covers the adjacent scan lines that are not electrically connected with the pixel electrode.

10. The E-ink display panel of claim 1, wherein the pixel electrode completely covers the corresponding bottom-gate TFT.

11. The E-ink display panel of claim 1, wherein the opposite substrate, comprising:
a substrate; and
a common electrode disposed between the substrate and the E-ink display medium.

12. The E-ink display panel of claim 1, wherein the E-ink display medium, comprising:
a plurality of dark-colored particles;
a plurality of light-colored particles; and
a transparent fluid, wherein the dark-colored particles and the light-colored particles are distributed in the transparent fluid and have different electric characteristics.

13. The E-ink display panel of claim 1, wherein the E-ink display medium, comprising a plurality of E-ink particles, wherein one side of the E-ink particles is light-colored, the other side thereof is dark-colored, and those two sides have different electric characteristics.

14. The E-ink display panel of claim 1, wherein the E-ink display medium, comprising:
a plurality of colored particles; and
a colored liquid, wherein the colored particles are suspended in the colored liquid.

15. The E-ink display panel of claim 1, wherein the E-ink display medium is wrapped inside a plurality of microcapsules.

16. The E-ink display panel of claim 1, wherein the E-ink display medium is contained in a plurality of microcups.
